(19) United States
(12) Patent Application Publication
(10) Pub. No.: US 2008/0237223 A1
(43) Pub. Date: Oct. 2, 2008

(54) INDUCTION HEATING DEVICE AND INDUCTION HEATING FIXING DEVICE

(75) Inventors: Satoshi Kinouchi, Shinjuku-ku (JP); Osamu Takagi, Chofu-shi (JP); Yoshinori Tsueda, Fuji-shi (JP); Toshihiro Sone, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/695,271

(22) Filed: Apr. 2, 2007

(51) Int. Cl. H05B 6/10

(52) U.S. Cl. 219/619

(57) ABSTRACT

An induction heating coil of an induction heating device of the invention is formed such that a first coil width of an active coil section parallel to a longitudinal direction of a heat roller and a second coil width of an end coil section in a direction parallel to a rotating direction of the heat roller are different. When the induction heating coil is divided into plural coils, portions having weak magnetic fields in joint portions of the induction heating coils, at both ends of the induction heating coils, or the like are narrowed.

### BACKGROUND OF THE INVENTION

1. Field of the Invention

The present invention relates to an induction heating device and an induction heating fixing device that are mounted on image forming apparatuses such as a copying machine, a printer, and a facsimile, have members to be heated by induction heating, and fix toner images on sheets using the members to be heated.

2. Description of the Related Art

Fixing devices used in image forming apparatuses such as a copying machine and a printer of an electrophotographic system, there are devices that insert sheet paper through a nip formed between a pair of rollers including a heat roller and a pressure roller or between belts similar to the rollers and heat, press, and fix toner images. In the fixing devices of the heating and pressing system, there are induction heating fixing devices that heat a heat roller or a heating belt with an induction heating system in order to realize an increase in process speed.

As one of the induction heating fixing devices, there is a device in which an induction heating coil is arranged on an outer side of a heat roller or a heating belt having a metal conductive layer to be opposed to the heat roller or the heating belt. Such a device generates an eddy-current in the metal conductive layer using a magnetic field generated by supplying predetermined electric power to the induction heating coil. The device instantaneously heats the metal conductive layer with this eddy-current and heats, for example, the heat roller. Moreover, in such fixing devices of the induction heating system, there is a device in which an induction heating coil is divided into plural coils in order to uniformalize a temperature distribution in a longitudinal direction of a heat roller.

However, magnetic field falls at ends of such an induction heating coil or, when the induction heating coil is divided into plural coils, in joint portions with adjacent induction heating coils. Therefore, it is likely that the temperature of the heat roller is reduced and temperature unevenness is caused in the heat roller at the ends of the induction heating coil or the joint portions with the adjacent induction heating coils.

For example, as shown in a Prior Art in FIG. 1 and FIG. 2, when plural conductors are wound in a simple shape, induction heating coils 102, 103, and 104 have substantially the same coil width over the entire circumference thereof. Therefore, at ends 103a and 104a of the induction heating coils 103 and 104 or in joint portions α1 and α2 of the induction heating coils 102, 103, and 104, an extent of the fall in magnetic fields occurs is widened. As a result, as shown in FIG. 2, it is likely that a surface temperature of a heat roller 106 corresponding to the ends 103a and 104a of the induction heating coils 103 and 104 and the joint portions α1 and α2 is reduced. In other words, it is likely that the heat roller 106 causes surface temperature unevenness.

Therefore, for example, in JP-A-2002-43049, an induction heating device in which induction coils are stacked in the vertical direction at ends in a longitudinal direction of a heat roller to heat only necessary places of the heat roller is disclosed.

However, when the induction heating coil is stacked in the vertical direction at the ends in the longitudinal direction of the heat roller, in joint portions adjacent to each other of plural coils formed by dividing the induction heating coil, a mutual induction current is generated between the induction heating coils. The mutual induction current between the adjacent induction heating coils increases as an opposed area of the induction heating coils becomes larger. This mutual induction current changes to a reactive current rather than a magnetic flux in a direction for heating the heat roller and reduces heating efficiency of the heat roller.

In particular, there is a device in which, in order to realize an increase in speed, a metal conductive layer having a smaller thickness and a smaller heat capacity is provided near the surface of a heat roller and the metal conductive layer is heated using induction heating coils on the outside. In such a device, it is likely that a mutual induction current generated in joint portions of the induction heating coils considerably affects temperature unevenness of the heat roller to cause a fixing failure.

Thus, in the heating device that heats the metal conductive layer using the induction heating coil, a temperature fall at the ends of the induction heating coil is prevented. In the heating device that heats the metal conductive layer using the induction heating coil divided into plural coils, temperature unevenness caused by the joint portion of the induction heating coils adjacent to each other is reduced. Therefore, an induction heating device that obtains uniformalization of temperature is desired. An induction heating fixing device that can obtain a satisfactory fixing property using this induction heating device is desired.

### SUMMARY OF THE INVENTION

In an aspect of the invention, when a metal conductive layer is heated using an induction heating coil, a temperature fall at ends of the induction heating coil is prevented and temperature unevenness due to a temperature fall in joint portions adjacent to each other of plural induction heating coils is reduced. As a result, there is provided an induction heating device in which the metal conductive layer is equally heated at high heating efficiency and temperature is equal over the full length in a longitudinal direction. Further, there is provided an induction heating fixing device that obtains a satisfactory fixing property with an equal quality and at high speed using this induction heating device.

According to an embodiment of the invention, an induction heating device includes an endless heating target member that has a metal conductive layer and an induction heating coil that is arranged on an outer periphery of the heating target member and formed by winding a conductor plural times and generates an induction current in the metal conductive layer. The induction heating device is characterized in that a first coil width in a direction parallel to a rotation axis of the heating target member and a second coil width in a direction parallel to a rotating direction of the heating target member of the induction heating coil are different.

### BRIEF DESCRIPTION OF THE DRAWINGS

FIG. 1 is a schematic explanatory diagram showing an arrangement of induction heating coils with respect to a heat roller of a Prior Art;

FIG. 2 is a graph showing a temperature distribution in a longitudinal direction of the heat roller of the Prior Art;

FIG. 3 is a schematic diagram showing an image forming apparatus mounted with a fixing device according to a first embodiment of the invention;

FIG. 4 is a schematic diagram showing the fixing device according to the first embodiment of the invention;

FIG. 5 is a schematic explanatory diagram of induction heating coils according to the first embodiment of the invention viewed from above;

FIG. 6 is a schematic explanatory diagram of the induction heating coils according to the first embodiment of the invention viewed from a side;

FIG. 7A is a schematic sectional view of a magnetic core according to the first embodiment of the invention;

FIG. 7B is a schematic sectional view showing a modification of the magnetic core according to the first embodiment of the invention;

FIG. 8 is a schematic explanatory diagram showing an arrangement of plural induction generating coils according to the first embodiment of the invention;

FIG. 9 is a block diagram showing a control system of the fixing device according to the embodiment of the invention;

FIG. 10 is a schematic explanatory diagram of the induction heating coils according to the first embodiment of the invention viewed from above with the magnetic cores omitted;

FIG. 11 is a schematic explanatory diagram showing a section of an active coil section of the inductive heating coils according to the first embodiment of the invention;

FIG. 12 is a schematic explanatory diagram showing a section of an end coil section of the induction heating coils according to the first embodiment of the invention;

FIG. 13 is a schematic explanatory diagram of induction heating coils according to a second embodiment of the invention viewed from above;

FIG. 14 is a schematic explanatory diagram of the induction heating coils according to the second embodiment of the invention viewed from a side;

FIG. 15 is a schematic perspective view of the induction heating coils according to the second embodiment of the invention;

FIG. 16 is a schematic explanatory diagram showing coil-like litz wire sections of the induction heating coil according to the second embodiment of the invention with magnetic cores removed;

FIG. 17 is a schematic explanatory diagram showing a stacked coil section of the induction heating coils according to the second embodiment of the invention;

FIG. 18 is a schematic explanatory diagram of induction heating coils according to a third embodiment of the invention viewed from above;

FIG. 19 is a schematic explanatory diagram of the induction heating coils according to the third embodiment of the invention viewed from a side;

FIG. 20 is a schematic perspective view of the induction heating coils according to the third embodiment of the invention;

FIG. 21 is a schematic explanatory diagram showing a stacked coil section of side coils according to the third embodiment of the invention; and

FIG. 22 is a schematic explanatory diagram showing a stacked coil section of a center coil according to the third embodiment of the invention.

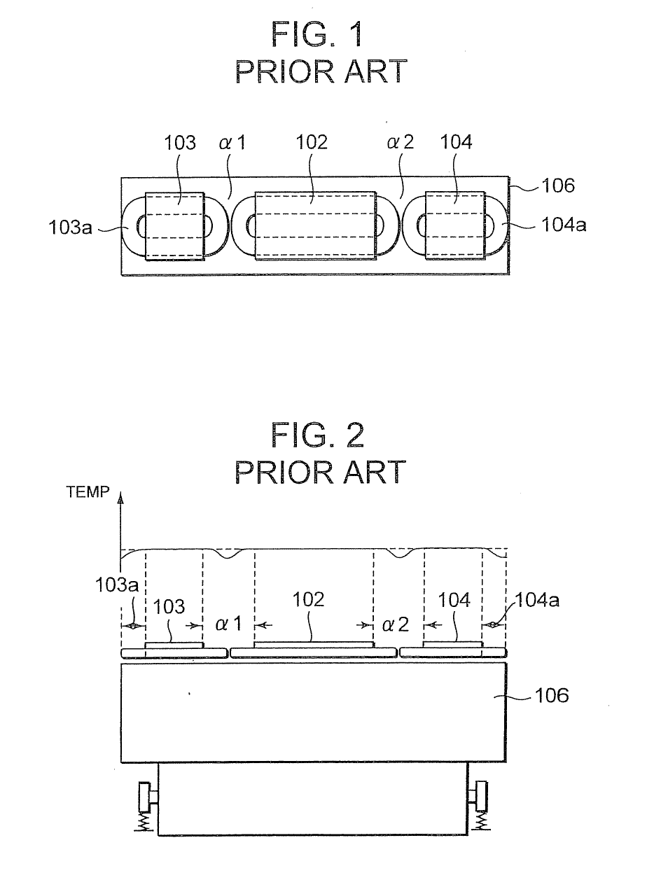

### DETAILED DESCRIPTION OF THE PREFERRED EMBODIMENT

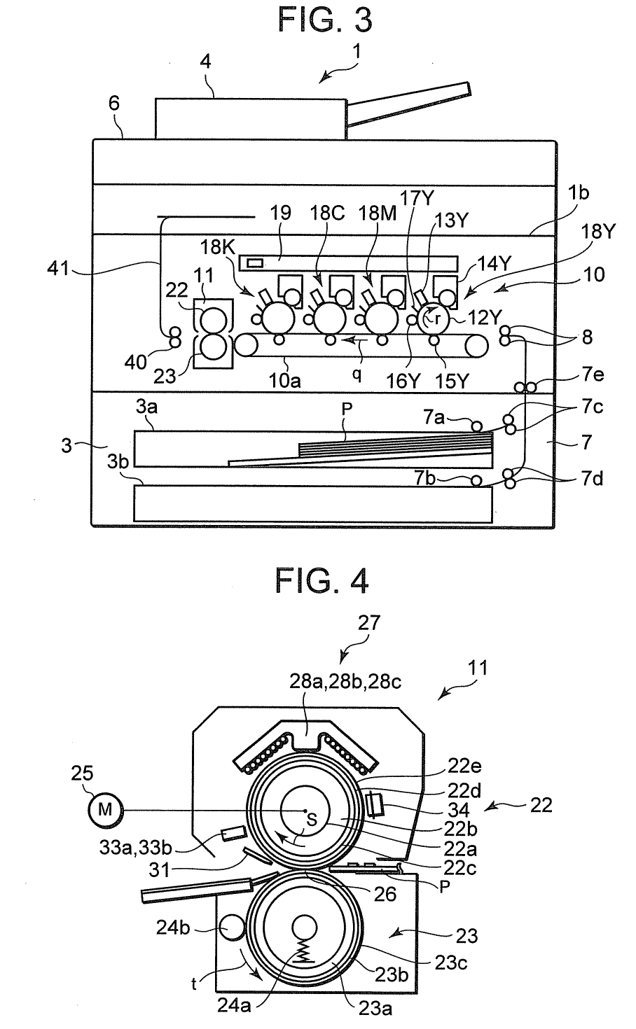

A first embodiment of the invention will be hereinafter explained in detail with the accompanying drawings as examples. FIG. 3 is a schematic diagram showing an image forming apparatus 1 mounted with a fixing device 11 serving as an induction heating and fixing device according to the first embodiment of the invention. A scanner unit 6 that scans an original supplied by an automatic document feeder 4 is provided on an upper surface of the image forming apparatus 1. The imaging forming apparatus 1 includes a cassette mechanism 3 that supplies sheet paper P, which is a fixing target medium, to an image forming unit 10.

The cassette mechanism 3 includes first and second paper feeding cassettes 3a and 3b. On a conveying path 7 leading from the respective paper feeding cassettes 3a and 3b to the image forming unit 10, pickup rollers 7a and 7b that take out sheet paper from the paper feeding cassettes 3a and 3b, separation conveying rollers 7c and 7d, conveying rollers 7e, and registration rollers 8 are provided. The image forming apparatus has, downstream of the image forming unit 10, a fixing device 11 that fixes a toner image formed on the sheet paper P by the image forming unit 10. Downstream of the fixing device 11, paper discharging rollers 40 are provided and a paper discharging and conveying path 41 that conveys the sheet paper P after having the toner image fixed thereon to a paper discharging unit 1b is provided.

The image forming unit 10 has image forming stations 18Y, 18M, 18C, and 18K of respective colors of yellow (Y), magenta (M), cyan (C), and black (K). The respective image forming stations 18Y, 18M, 18C, and 18K are arrayed in tandem along a transfer belt 10a that is rotated in an arrow q direction.

The image forming station 18Y of yellow (Y) is constituted by arranging a charging device 13Y, a developing device 14Y, a transfer roller 15Y, a cleaner 16Y, and a charge removing device 17Y that are process members around a photoconductive drum 12Y serving as an image bearing member that rotates in an arrow r direction. Above the image forming station 18Y of yellow (Y), a laser exposure device 19 that irradiates a laser beam on the photoconductive drum 12Y is provided.

The image forming stations 18M, 18C, and 18K of the respective colors of magenta (M), cyan (C), and black (K) have the same structure as the image forming station 18Y of yellow (Y).

In the image forming unit 10, according to the start of print operation, in the image forming station 18Y of yellow (Y), the photoconductive drum 12Y rotates in the arrow r direction and is uniformly charged by the charging device 13Y. Subsequently, exposure light corresponding to image information scanned by the scanner unit 6 is irradiated on the photoconductive drum 12Y by the laser exposure device 19 and an electrostatic latent image is formed on the photoconductive drum 12Y. A toner image is formed on this photoconductive drum 12Y by the developing device 14Y. In the position of the transfer roller 15Y, the toner image is transferred onto the sheet paper P conveyed in the arrow q direction on the transfer belt 10a. After the transfer is finished, the remaining toner on the photoconductive drum 12Y is cleaned by the cleaner 16Y and electric charges on the surface of the photoconductive drum 12Y are removed by the charge removing device 17Y. Consequently, the photoconductive drum 12Y is capable of performing the next print.

The image forming stations 18M, 18C, and 18K of the respective colors of magenta (M), cyan (C), and black (K) perform image forming operation in the same manner as the image forming station 18Y of yellow (Y) and form a full-color toner image on the sheet paper P. Thereafter, the sheet paper P is heated and pressed to have the toner image fixed thereon and have a print image completed thereon by the fixing device 11 serving as the induction heating fixing device and is discharged to the paper discharging unit 1b.

The fixing device 11 will be described. FIG. 4 is a schematic diagram showing the fixing device 11. The fixing device 11 has a heat roller 22 serving as an endless heating target member and a press roller 23 serving as a pressing member. The heat roller 22 is driven in an arrow s direction by a driving motor 25. The press roller 23 is brought into press-contact with the heat roller 22 by a compression spring 24a. Consequently, a nip 26 of a fixed width is formed between the heat roller 22 and the press roller 23. The press roller 23 rotates in an arrow t direction following the heat roller 22.

Moreover, an induction heating coil 27 that heats the heat roller 22 is arranged to be opposed to the heat roller 22 via a gap on an outer side of the heat roller 22 of the fixing device 11. Moreover, on an outer periphery of the heat roller 22, a peeling pawl 31 that prevents twining of the sheet paper P after fixing, a first thermistor 33a and a second thermistor 33b that detect a surface temperature of the heat roller 22, and a thermostat 34 that detects abnormality of the surface temperature of the heat roller 22 and interrupts heating are provided. A cleaning roller 24b is provided on an outer periphery of the press roller 23.

When it is unlikely that the sheet paper P twines around the heat roller, the peeling pawl 31 does not have to be provided. The number of thermistors is not limited to two. It is possible to arrange a necessary number of thermistors in necessary places in a longitudinal direction of the heat roller 22, which is a rotation axis π direction of the heat roller 22.

In the heat roller 22, foamed rubber (sponge) 22b, a metal conductive layer 22c made of nickel (Ni) or the like, a solid rubber layer 22d, and a release layer 22e are formed around a core bar 22a. For example, the diameter of the core bar 22a is about 30 mm, the thickness of the foamed rubber (sponge) 22b is 5 mm, the thickness of the meal conductive layer 22c is 40 μm, the thickness of the solid rubber layer 22d is 200 μm, and the thickness of the release layer 22e is 30 μm. The metal conductive layer 22c is not limited to nickel and may be stainless steel, aluminum, a composite of stainless steel and aluminum, and the like.

The press roller 23 has a core bar 23a and a rubber layer 23b of silicon rubber, fluorine rubber, or the like around the core bar 23a. A release layer 23c is coated over the rubber layer 23b. Both the heat roller 22 and the press roller 23 are formed with a diameter of, for example, 40 mm. The sheet paper P passes through the nip 26 between the heat roller 22 and the press roller 23, whereby a toner image on the sheet paper P is heated, pressed, and fixed thereon.

The press roller 23 may have, as required, a metal conductive layer heated by induction heating coils or may have a heating mechanism, for example, have a halogen lamp heater built therein.

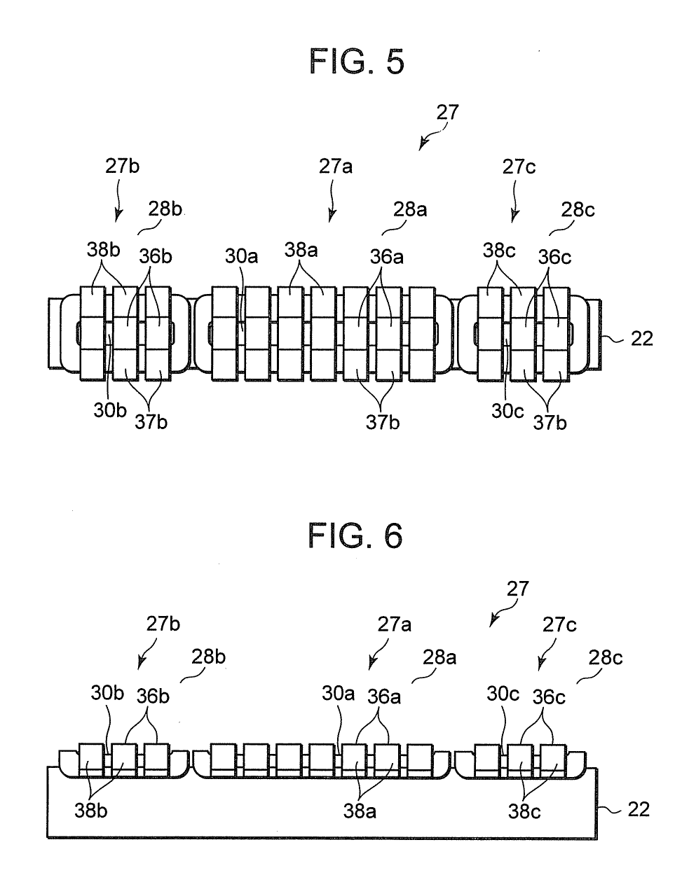

The induction heating coil 27 will be described. As shown in FIG. 5 and FIG. 6, the induction heating coil 27 is divided into three coils, namely, a center coil 27a, a first side coil 27b, and a second side coil 27c. In this embodiment, the first side coil 27b and the second side coil 27c are connected in series and driven by the same control. The center coil 27a and the first and the second side coils 27b and 27c use magnetic cores 28a, 28b, and 28c, respectively, to concentrate magnetic fluxes in the heat roller 22 and improve a magnetic characteristic. The magnetic cores 28a, 28b, and 28c are divided into plural cores, respectively.

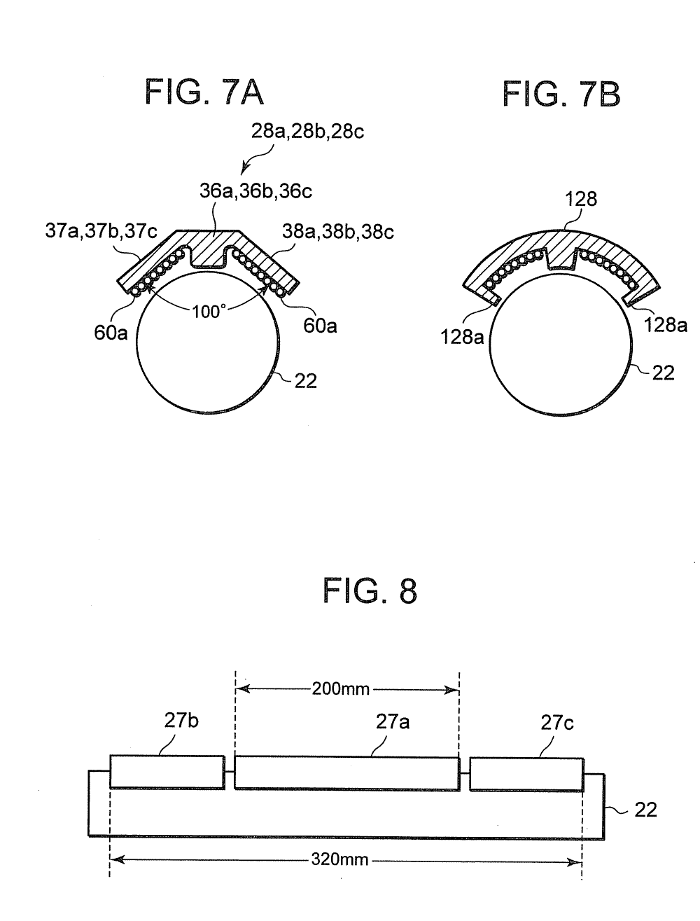

As show in FIG. 7A, the magnetic cores 28a, 28b, and 28c are formed in substantially a roof shape that is bent to be inclined to both sides in section. The magnetic cores 28a, 28b, and 28c are formed by bending left sides 37a, 37b, and 37c and right sides 38a, 38b, and 38c at a fixed angle from center portions 36a, 36b, and 36c located in respective window sections 30a, 30b, and 30c of the center coil 27a, the first side coil 27b, and the second side coil 27c. In this embodiment, the angle between the left sides 37a, 37b, and 37c and the right sides 38a, 38b, and 38c of the magnetic cores 28a, 28b, and 28c is formed at, for example, an internal angle of 100° over the full length in the longitudinal direction of the heat roller 22 along a surface shape of the heat roller 22.

A shape of the magnetic cores is not limited. For example, as shown in FIG. 7B, the magnetic cores may be a magnetic core 128 of an arcuate shape having a section parallel to the surface of the heat roller 22 such that the magnetic core 128 is formed along the surface of the heat roller 22. Moreover, if magnetic shielding sections 128a are protrudingly provided on both sides of the magnetic core 128, it is possible to further increase the concentration of magnetic fluxes in the heat roller 22.

As shown in FIG. 8, the center coil 27a has a length of 200 mm and heats a center area of the heat roller 22. The first and the second side coils 27b and 27c are arranged on both sides of the center coil 27a. The first and the second side coils 27b and 27c are connected in series and driven by the same control. The full length 320 mm of the heat roller 22 is heated by the center coil 27a and the first and the second side coils 27b and 27c. The center coil 27a and the first and the second side coils 27b and 27c are alternately switched and outputted. However, the outputs of the center coil 27a and the first and the second side coils 27b and 27c may be simultaneous.

The induction heating coil 27 generates a magnetic flux when a high-frequency current is applied thereto. With this magnetic flux, the induction heating coil 27 generates an eddy-current in the heat roller 22 to prevent a change in a magnetic field. Joule heat is generated in the metal conductive layer 22c by this eddy-current and the resistance of the heat roller 22 and the heat roller 22 is heated. In this embodiment, for example, while the heat roller 22 is rotated twice, the temperature of the heat roller 22 is raised to a fixable temperature. The first thermistor 33a detects the temperature of the heat roller 22 heated by the center coil 27a. The second thermistor 33b detects the temperature of the side of the heat roller 22 heated by the second side coil 27c.

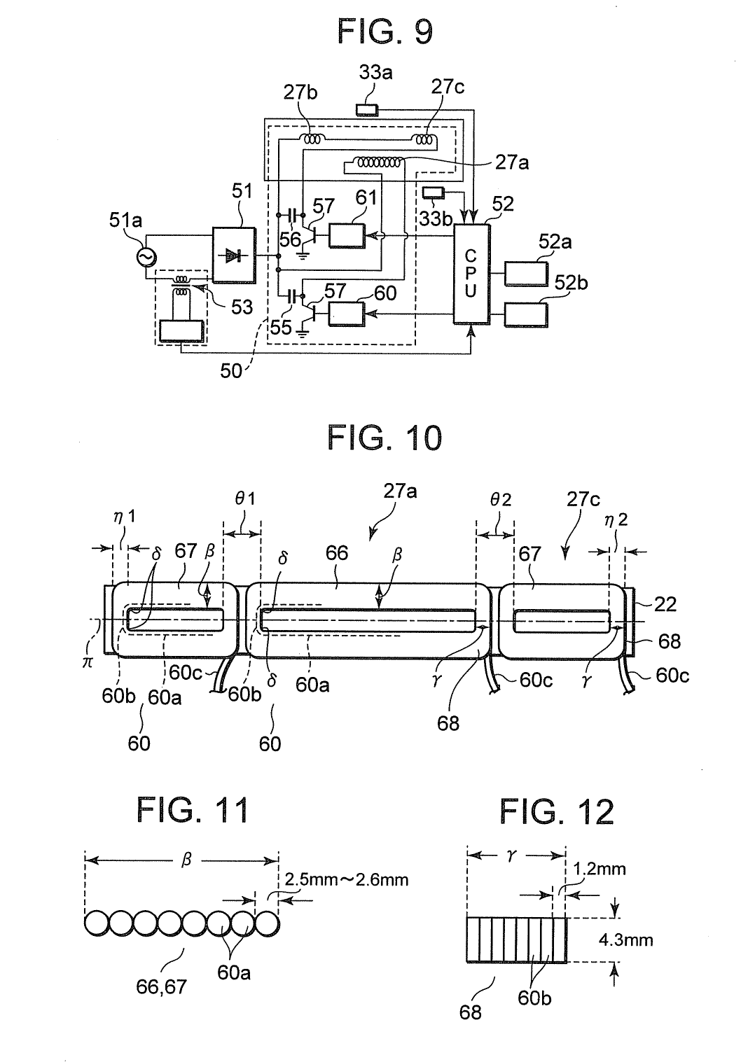

The induction heating coil 27 is driven by a control system 100 shown in FIG. 9 and heats the heat roller 22. The control system 100 has an inverter circuit 50 that supplies driving currents to the center coil 27a and the first and the second side coils 27b and 27c, a rectifier circuit 51 that supplies DC power of 100 V to the inverter circuit 50, and a CPU 52 that controls the entire image forming apparatus 1 and controls the inverter circuit 50 according to detection results of the thermistors 33a and 3bb.

The CPU 52 has a main memory 52a, a storage device 52b, or the like. The inverter circuit 50 selectively switches and drives the center coil 27a or the first and the second side coils 27b and 27c according to the detection results of the thermistors 33a and 33b. According to the detection results of the thermistors 33a and 33b, a command for instructing, for example, which of the center coil 27a and the first and the second side coils 27b and 27c should be driven, whether all the coils should be turned off, or to which value an output value to the coils should be set is outputted from the CPU 52.

The rectifier circuit 51 rectifies an electric current from a commercial AC power supply 51a into a direct current of 100 V and supplies the direct current to the inverter circuit 50. A transformer 53 is arranged at a pre-stage of the rectifier circuit 51. This makes it possible to detect all power consumptions. Electric power provided from the commercial AC power supply 51a is detected and fed back to the CPU 52.

As the inverter circuit 50, a quasi-E class circuit that drives one coil with one switching element is used. However, the inverter circuit may have a circuit specification that uses a circuit of a half bridge type that performs output adjustment according to pulse width (PWM) control rather than subjecting a change in an output to frequency adjustment using two switching elements.

Capacitors 55 and 56 for resonance are connected to the center coil 27a and the first and the second side coils 27b and 27c in parallel. Switching elements 57 and 58 are connected to the capacitors 55 and 56, respectively. As the switching elements 57 and 58, IGBT, MOS-FET, or the like usable under a high withstand pressure and a large current is used.

Driving circuits 60 and 61 are connected to control terminals of the switching elements 57 and 58, respectively. The driving circuits 60 and 61 apply driving voltages to the control terminals of the switching elements 57 and 58 to turn on the switching elements 57 and 58. The CPU 52 controls driving voltage application timing of the driving circuits 60 and 61. The inverter circuit 50 controls ON times of the switching elements 57 and 58 using the CPU 52, changes a frequency in a range of 20 to 50 kHz, and feeds an electric current to the center coil 27a or the first and the second side coils 27b and 27c. The inverter circuit 50 changes a driving frequency to make it possible to supply electric power of 700 W to 1500 W to the center coil 27a or the first and the second side coils 27b and 27c.

In the induction heating coil 27, a litz wire 60 having the diameter of about 2.5 to 2.6 mm formed by twisting, for example, nineteen copper wires having the wire diameter of 0.5 mm is used as a conductor. As an insulating material for the copper wire, heat-resistant polyamide-imide is used. The electric wire and the insulating material are not limited to these and the wire diameter is arbitrary. When such a litz wire is used, a structure thereof is arbitrary. The litz wire may be a wire formed by simply binding plural copper wires. The number and the thickness of the copper wires are not limited either. The induction heating coil 27 is formed by winding the litz wire 60 around the magnetic cores 28a, 28b, and 28c, for example, eight times.

As shown in FIG. 10, the litz wire 60 of the induction heating coil 27 is wound around the magnetic cores 28a, 28b, and 28c such that an inner peripheral angle δ of a litz wire 60a in a direction parallel to a rotation axis π of the heat roller 22 and a litz wire 60b in a direction parallel to the rotating direction of the heat roller 22 form a substantially right angle. Both the litz wire 60a in the direction parallel to the rotation axis π of the heat roller 22 and the litz wire 60b in the direction parallel to the rotating direction of the heat roller 22 are formed substantially linearly.

The litz wire 60a in the direction parallel to the rotation axis π of the heat roller 22 holds a sectional shape of a circle having a diameter of about 2.5 to 2.6 mm. The litz wire 60b in the direction parallel to the rotating direction of the heat roller 22 is compressed to a substantially rectangular sectional shape of 4.3 mm long and 1.2 mm wide. In other words, the litz wire 60a in the direction parallel to the rotation axis π of the heat roller 22 is not compressed (a compression ratio is 1) and the litz wire 60b in the direction parallel to the rotating direction of the heat roller 22 is compressed in the horizontal direction at a compression ratio of 1.2/2.6≡0.46.

In the induction heating coil 27, it is possible to compress the litz wire 60b in the direction parallel to the rotating direction of the heat roller 22 by processing the litz wire 60 with a pressing machine. Alternatively, the litz wire 60b in the direction parallel to the rotating direction of the heat roller 22 may be press-molded every time the litz wire 60 is wound. The litz wire 60 is wound eight times and molded in a coil shape and, then, coil sections are hardened with varnish. However, a draw-out portion 60c of the litz wire 60 is not subjected to varnish treatment. Consequently, the draw-out portion 60c keeps flexibility and it is easy to perform processing for wire connection with the inverter circuit 50.

In general, a section of a litz wire is circular. An outer diameter D thereof is generally calculated by (Equation 1).

Outer diameter D=1.155×d×√Nmm (Equation 1)

(Here, d is an outer diameter (mm) of element wires of a copper wire or the like forming the litz wire. N is the number of the element wires.)

From (Equation 1) above, the Outer diameter D of the litz wire 60 according to this embodiment is D≈2.517.

A first coil width β of active coil sections 66 and 67 in the direction parallel to the rotation axis π of the heat roller 22 of the inductive heating coil 27 formed by such a litz wire 60 is 2.6×8=20.8 mm at the maximum. On the other hand, a second coil width γ of an end coil section 68 in the direction parallel to the rotating direction of the heat roller 22 is formed at about 1.2×8=9.6 mm, which is equal to or smaller than ½ of the first coil width β. Sectional shapes of the active coil sections 66 and 67 and the end coil section 68 of the induction heating coil 27 are shown in FIG. 11 and FIG. 12, respectively.

Since the second coil width γ of the end coil section 68 is formed at 9.6 mm, the width of joint portions θ1 and θ2 of the center coil 27a and the first and the second side coils 27b and 27c is about 19.2+1=20.2 mm when a gap between coils adjacent to each other is 1 mm. The gap of about 1 mm provided in the joint portions of the center coil 27a and the adjacent first and second side coils 27b and 27c is a gap for preventing adjacent coils from coming into contact with each other. An insulating material such as an insulating tape or an insulating sheet may be provided instead of the gap to prevent contact of the adjacent coils. On the other hand, as a comparative example, in a coil formed by not compressing the litz wire 60, the joint portions θ1 and θ2 are about 41.6 mm. The width of the joint portions θ1 and θ2 of the induction heating coil 27 according to this embodiment is about ½ compared with the coil formed by not compressing the litz wire 60. Both ends η1 and η2 of the first and the second side coils 27b and 27c are formed in the same manner as the joint portions and have the coil width γ. Therefore, the width of both the ends η1 and η2 of the first and the second side coils 27b and 27c is also about ½ of the coil formed by not compressing the litz wire 60. As a result, it is possible to reduce a temperature fall of the metal conductive layer 22c in the joint portions θ1 and θ2 and at both the ends η1 and η2 of the induction heating coil 27 and reduce temperature unevenness of the heat roller 22.

Moreover, by partially compressing the litz wire 60 in this way, in the induction heating coil 27, it is possible to reduce the full length of the litz wire 60 while securing the active coil sections 66 and 67 of a necessary length. As a result, when an electric current is generated, it is possible to reduce useless Joule heat due to a copper loss of the litz wire 60 and improve heat generation efficiency of the metal conductive layer 22c.

Next the Actions will be described. According to the start of an image forming process, in the image forming unit 10, toner images are formed on the photoconductive drums 12Y, 12M, 12C, and 12K, respectively, in the image forming stations 18Y, 18M, 18C, and 18K of the respective colors yellow (Y), magenta (M), cyan (C), and black (K). The toner images on the photoconductive drums 12Y, 12M, 12C, and 12K are transferred onto the sheet paper P on the transfer belt 10a rotated in the arrow q direction by the transfer rollers 15Y, 15M, 15C, and 15K to form a full-color toner image on the sheet paper P. Thereafter, the sheet paper P passes through the nip 26 between the heat roller 22 and the press roller 23 of the fixing device 11 to have the toner image heated, pressed, and fixed thereon and a print image completed thereon.

According to the start of the image forming process, in the fixing device 11, the heat roller 22 is driven in the arrow s direction by the driving motor 25 and the press roller 23, which follows the heat roller 22 is rotated in the arrow t direction. Moreover, in the fixing device 11, in accordance with a detection result of a surface temperature of the heat roller 22 by the first and the second thermistors 33a and 33b, the CPU 52 controls the driving circuits 60 and 61 of the inverter circuit 50, respectively.

The driving circuits 60 and 61 supply electric power of 900 W to the center coil 27a and/or the first and the second side coils 27b and 27c, respectively, according to a size of the sheet paper P. When the sheet paper P is paper of a full size such as the A4 horizontal size of the JIS standard (297×210 mm) or the A3 size (297×420 mm), the fixing device 11 supplies electric power to the center coil 27a and the first and the second side coils 27b and 27c to heat the full length in the longitudinal direction of the heat roller 22. When the sheet paper P is paper of a small size such as the A4 vertical size (210×297 mm) or a postcard size (100×148 mm) of the JIS standard, the fixing device 11 supplies electric power only to the center coil 27a and heats a part of the center of the heat roller 22. Consequently, the induction heating coil 27 raises the temperature of a necessary portion of the heat roller 22 to a fixing temperature of, for example, 160° C. at high speed of about 30 seconds and makes it possible to fix an image.

According to this embodiment, in the induction heating coil 27 formed by turning the litz wire 60 eight times, the second coil width γ is set to be equal to or smaller than ½ of the first coil width β of the active coil sections 66 and 67 by compressing the litz wire 60b of the end coil section 68.

Therefore, it is possible to reduce the width of the joint portions θ1 and θ2 of the center coil 27a and the first and the second side coils 27b and 27c of the heat roller 22. It is also possible to reduce the width of both the ends η1 and η2 of the first and the second side coils 27b and 27c. Therefore, when the full length of the heat roller 22 is heated, it is possible to reduce a temperature fall of the metal conductive layer 22c caused by the width of the joint sections θ1 and θ2 or the width of both the ends η1 and η2 of the induction heating coil 27. As a result, in the joint portions θ1 and θ2 or both the ends η1 and η2 of the induction heating coil 27, it is possible to reduce temperature unevenness, which means that a temperature fall is caused in the heat roller 22, and a more uniform fixing temperature is obtained over the full length of the heat roller 22.

As a result of compressing the litz wire 60b of the end coil section 68 to reduce the second coil width γ to be equal to or smaller than ½ of the first coil width β, it is possible to reduce the full length of the litz wire 60 of the induction heating coil 27 while securing the active coil sections 66 and 67 at a necessary length. According to the reduction of the full length of the litz wire 60, when an electric current is generated, it is possible to reduce useless Joule heat due to a copper loss of the litz wire 60 and further improve heat generation efficiency of the metal conductive layer 22c.

A second embodiment of the invention will be explained. This second embodiment is different from the first embodiment in a shape of the induction heating coil. Otherwise, the second embodiment is the same as the first embodiment. Therefore, in the second embodiment, components identical with the components explained in the first embodiment are denoted by the identical reference numerals and signs and detailed explanations of the components are omitted.

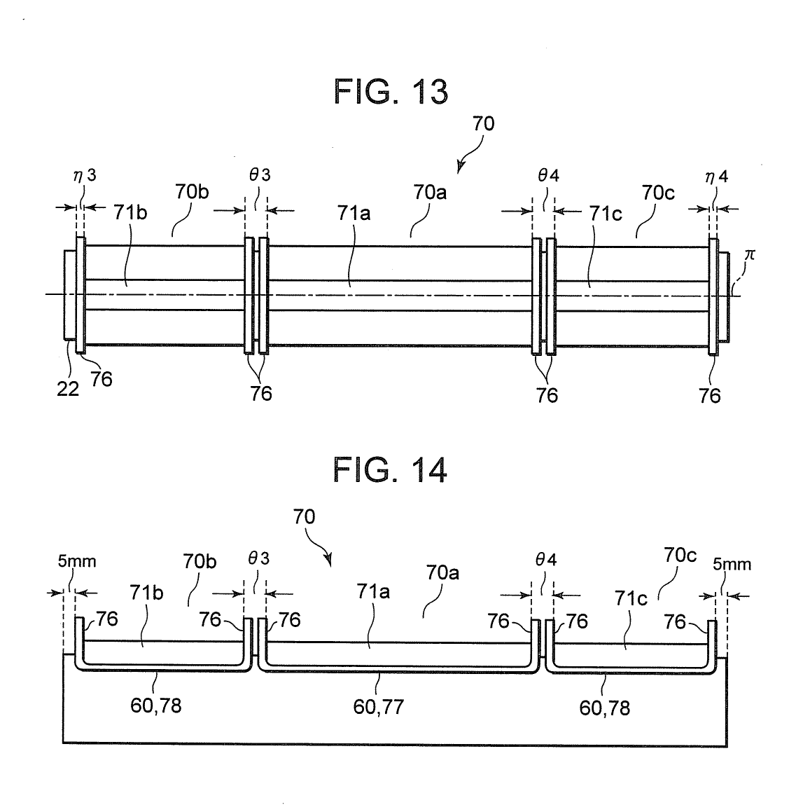

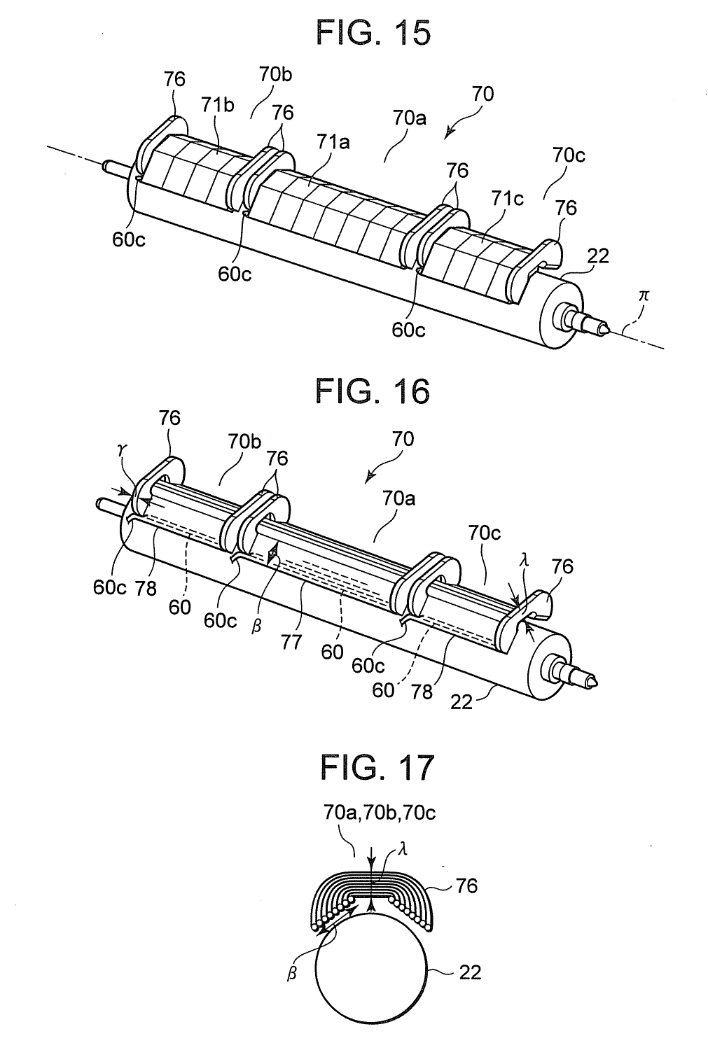

The second embodiment has, as shown in FIG. 13 to FIG. 17, an induction heating coil 70 that heats the heat roller 22. The induction heating coil 70 is divided into three coils, namely, a center coil 70a and first and second side coils 70b and 70c. The center coil 70a has a length of 200 mm. The full length 320 mm of the heat roller 22 is heated by the center coil 70a and the first and the second side coils 70b and 70c. The induction heating coil 70 has magnetic cores 71a, 71b, and 71c having a roof shape in section. An internal angle of sections of the magnetic cores 71a, 71b, and 71c is inclined at 100°. The induction heating coil 70 is controlled to be driven by a control system same as the control system 100 in the first embodiment.

In the induction heating coil 70, the litz wire 60 same as that in the first embodiment is used as a conductor. The induction heating coil 70 is formed by winding the litz wire 60 around the magnetic cores 71a, 71b, and 71c same as those in the first embodiment, for example, eight times. At ends of the magnetic cores 71a, 71b, and 71c, the litz wires 60 are stacked and arrayed in a direction apart from the heat roller 22. In other words, in active coil sections 77 and 78 parallel to the longitudinal direction of the heat roller 22, which is the direction parallel to the rotation axis π of the heat roller 22, the litz wire 60 is simply wound around the magnetic cores 71a, 71b, and 71c without being stacked. Consequently, the active coil sections 77 and 78 of the induction heating coil 70 are formed in a plane shape along the inclinations of the magnetic cores 71a, 71b, and 71c. In the active coil sections 77 and 78, the litz wire 60 is not compressed (a compression ratio is 1) and keeps a sectional shape of a circle having a diameter of about 2.5 to 2.6 mm.

On the other hand, at the ends of the magnetic cores 71a, 71b, and 71c in the direction parallel to the rotating direction of the heat roller 22, the litz wires 60 are sequentially stacked on one litz wire 60 to form stacked coil sections 76. The litz wires 60 in the stacked coil sections 76 are compressed in a substantially rectangular sectional shape 4.3 mm long and 1.2 mm wide. In other words, the litz wire 60 is not compressed in the active coil sections 77 and 78 (a compression ratio is 1) and, in the stacked coil sections 76, the litz wires 60 are compressed in the horizontal direction at a compression ratio of 1.2/2.6≈0.46.

In the stacked coil sections 76, the litz wires 60 are compressed by processing the litz wires 60 in the press machine or press-molding the litz wires 60 every time the litz wire 60 is wound. The litz wire 60 is wound eight times and molded in a coil shape and, then, coil sections are hardened with varnish. However, the draw-out portion 60c of the litz wire 60 is not subjected to varnish treatment to keep flexibility.

In the induction heating coil 70 made of such a litz wire 60, as in the first embodiment, the first coil width β of the active coil sections 77 and 78 is 2.6×8=20.8 mm at the maximum. On the other hand, the second coil bending width γ in the stacked coil sections 76 at the ends of the magnetic cores 71a, 71b, and 71c is formed at about 4.3 mm, which is equal to or smaller than ¼ of the first coil width β.

By sequentially stacking the litz wires 60 at the end sides of the magnetic cores 71a, 71b, and 71c to form the stacked coil sections 76 in this way, it is possible to set the width of joint portions θ3 and θ4 of the center coil 70a and the first and the second side coils 70b and 70c to 8.6+1=9.6 mm. In other words, compared with a simply wound coil, it is possible to narrow portions with weak magnetic fields by setting the center coil 70a and the first and the second coils 70b and 70c closer to each other. Therefore, it is possible to intensify magnetic fields of the joint portions θ3 and θ4. In the joint portions of the center coil 70a and the first and the second side coils 70b and 70c, a gap of about 1 mm is provided to prevent adjacent coils from coming into contact with each other. An insulating material may be provided instead of the gap to prevent the contact of the adjacent coils.

The width of both ends Θ3 and Θ4 of the first and the second side coils 70b and 70c is also set to 4.3 mm equivalent to one litz wire compressed in a rectangular shape. Therefore, it is also possible to intensify magnetic fields of both the ends η3 and η4 of the first and the second side coils 70b and 70c. As a result, it is possible to further reduce a temperature fall of the metal conductive layer 22c in the joint portions θ3 and θ4 and at both the ends η3 and η4 of the induction heating coil 70 and reduce temperature unevenness of the heat roller 22. A distance from ends of both the ends η3 and η4 of the first and the second side coils 70b and 70c to the end the heat roller 22 is set to, for example, 5 mm as shown in FIG. 14. However, the distance is not limited to this.

Moreover, since the stacked coil sections 76 at the ends of the induction heating coil 70 are not opposed to the heat roller 22, magnetic fluxes generated in the stacked coil sections 76 do not contribute to heating of the heat roller 22. Therefore, when areas of the stacked coil sections 76 are large, a ratio of reactive currents in portions of the induction heating coil 70 not contributing to heating of the heat roller 22 increases. In other words, an efficiency characteristic of the induction heating coil 70 is reduced.

For example, as a comparative example, inductance L of a coil formed by not compressing the litz wire 60 in the stacked coil sections 76 at the ends of the induction heating coil 70 is 30 μ(H) and load resistance R obtained by magnetic combination with the coil and the heat roller 22 is 1.0(Ω).

On the other hand, inductance L of the induction heating coil 70 according to this embodiment in which the litz wires 60 in the stacked coil sections 76 at the ends are compressed to be 4.3 mm long and 1.2 mm wide and areas of the stacked coil sections 76 are reduced is 28 μ(H) and load resistance R obtained by magnetic combination of the coil and the heat roller 22 is 1.0(Ω). In other words, compared with the coil in the comparative example, the induction heating coil 70 in this embodiment has a larger ratio of the load resistance R to the inductance L. This means that the magnetic combination of the induction heating coil 70 and the heat roller 22 is strong and, when the same heat generation amount is obtained, it is possible to reduce an electric current fed to the induction heating coil 70. When the electric current flowing to the induction heating coil 70 is small, even if a size of a litz wire is the same, it is possible to reduce a copper loss. As a result, it is possible to improve heating efficiency of the heat roller 22 and save energy consumption of the fixing device 11.

The center coil 70a and the first and the second side coils 70b and 70c of the induction heating coil 70 have different ratios of the stacked coil sections 76 to the active coil sections 77 and 78 parallel to the longitudinal direction of the heat roller 22. In other words, the first and the second side coils 70b and 70c having two stacked coil sections 76 for each of the side coils 70b and 70c have a large ratio of the stacked coil sections 76 compared with the center coil 70a.

Therefore, for example, when the stacked coil sections 76 are formed without compressing the litz wires 60, in particular, in the first and the side coils 70b and 70c, a ratio of the load resistance R to the inductance L is too small. As a result, a switching loss of the inverter circuit 50 that drives the first and the second side coils 70b and 70c increases. Therefore, it may be necessary to set performance of a cooling mechanism for the inverter circuit 50 higher than that in the past to prevent a temperature rise of a switching element from exceeding a specification range. In terms of preventing such a phenomenon, it is necessary to reduce reactive currents not contributing to the heating of the heat roller 22 by compressing the litz wires 60 of the stacked coil sections 76 not used for the heating of the heat roller 22 and reducing the height of the stacked coil sections 76.

Moreover, another effect of compressing the stacked coil sections 76 is reduction of the height λ of the stacked coil sections 76. When the height λ of the stacked coil sections 76 is reduced, in the joint portions θ3 and θ4 of the induction heating coil 70, it is possible to reduce mutual induction currents generated between the center coil 70a and the first and the second side coils 70b and 70c adjacent to each other. In this embodiment, when the center coil 70a and the first and the second side coils 70b and 70c are set in closer to each other in order to keep a uniform fixing temperature over the full length in the longitudinal direction of the heat roller 22, the adjacent stacked coil sections 76 are also set closer to each other. As a result, in the joint portions θ3 and θ4, the center coil 70a and the first and the second side coils 70b and 70c adjacent to the center coil 70a cause mutual induction each other and cause an induction current and noise on the other side.

When the noise due to the mutual induction current increases to be equal to or larger than a fixed level, it is likely that malfunction of the inverter circuit 50 that drives the induction heating coil 70 is caused. In other words, it is likely that timing of switching by the switching elements 57 and 58 of the inverter circuit shifts due to the noise, a switching loss is caused, and the heat roller 22 cannot be heated to a predetermined fixing temperature.

The noise due to the mutual induction current is larger as areas of the joint portions θ3 and θ4 opposed to the stacked coil sections 76 are larger. Therefore, it is possible to reduce adverse influences of the noise due to the mutual induction current if the litz wires 60 in the stacked coil sections 76 are compressed, the height of the stacked coil sections 76 is reduced, and the areas are reduced.

Moreover, by compressing the litz wires 60 in the stacked coil sections 76 and reducing the height λ of the stacked coil sections 76, it is possible in the induction heating coil 70 to reduce the full length of the litz wire 60 while securing the active coil sections 77 and 78 of a necessary length. As a result, when an electric current is generated, it is possible to reduce useless Joule heat due to a copper loss of the litz wire 60 and improve heat generation efficiency of the metal conductive layer 22c.

According to this embodiment, in the induction heating coil 70, the stacked coil sections 76 are formed by stacking the litz wires 60 at the ends of the magnetic cores 71a, 71b, and 71c. Therefore, it is possible to form the stacked coil sections 76 to be very small such that the second coil width y thereof is reduced to be equal to or smaller than ¼ of the first coil width β of the active coil sections 77 and 78. Consequently, it is possible to reduce the width of the joint portions θ3 and θ4 and the width of both the ends η3 and η4 of the first and the second side coils 70b and 70c of the induction heating coil 70. Therefore, when the full length of the heat roller 22 is heated, it is possible to reduce a temperature fall of the metal conductive layer 22c caused by the width of the joint portions θ3 and θ4 or the width of both the ends η3 and η4 of the induction heating coil 70. As a result, it is possible to reduce temperature unevenness, which means that a temperature fall is caused in the heat roller 22, at the joint portions θ3 and θ4 or the both ends η3 and η4 of the induction heating coil 70 and a more uniform fixing temperature is obtained over the full length of the heat roller 22.

In this embodiment, the litz wires 60 in the stacked coil sections 76 are compressed to reduce areas of the stacked coil sections 76. As a result, it is possible to reduce a ratio of reactive currents of portions of the induction heating coil 70 not contributing to heating of the heat roller 22 and energy consumption of the fixing device 11 is saved according to improvement of heating efficiency of the induction heating coil 70.

Moreover, according to this embodiment, it is possible to reduce a mutual induction current between the center coil 70a and the first and the second side coils 70b and 70c adjacent to the center coil 70a by compressing the litz wires 60 in the stacked coil sections 76, reducing the height λ of the stacked coil sections 76, and reducing areas of the joint portions θ3 and θ4 of the induction heating coil 70 opposed to the stacked coil sections 76. As a result, it is possible to prevent malfunction of the inverter circuit 50 caused by noise due to the mutual induction current and surely heat the heat roller 22 to a desired fixing temperature.

Furthermore, by reducing the height λ of the stacked coil sections 76, it is possible to reduce the full length of the litz wire 60 of the induction heating coil 70 while securing the active coil sections 77 and 78 at a necessary length. As a result, when an electric current is generated, it is possible to reduce useless Joule heat due to a copper loss of the litz wire 60 and further improve heat generation efficiency of the metal conductive layer 22c.

A third embodiment of the invention will be explained. This third embodiment is different from the second embodiment in a shape of the stacked coil sections. Otherwise, the third embodiment is the same as the second embodiment. Therefore, in the third embodiment, components identical with the components explained in the second embodiment are denoted by the identical reference numerals and signs and detailed explanations of the components are omitted.

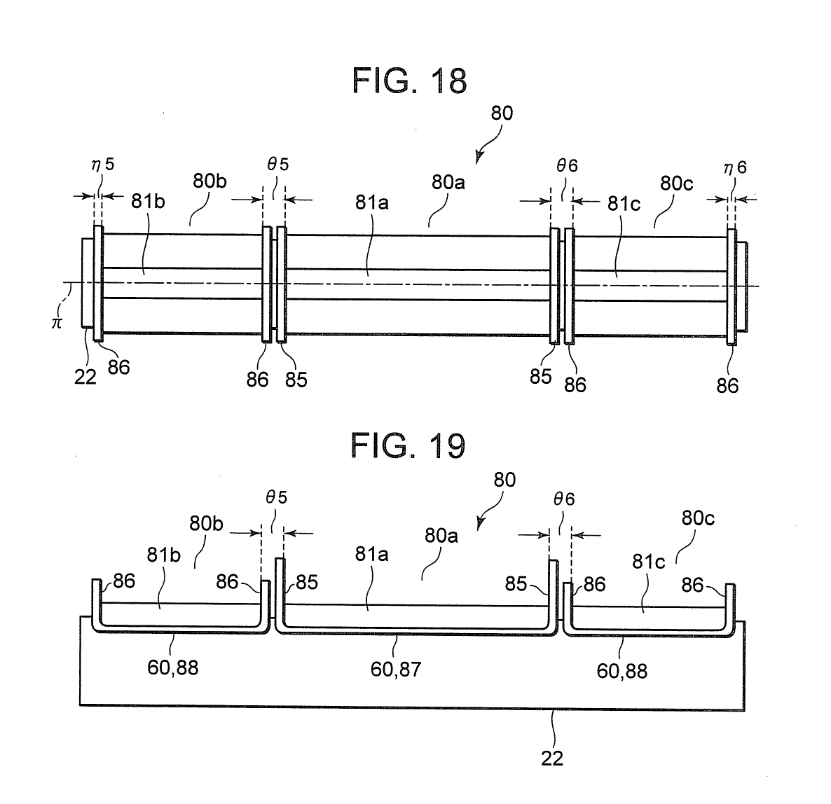

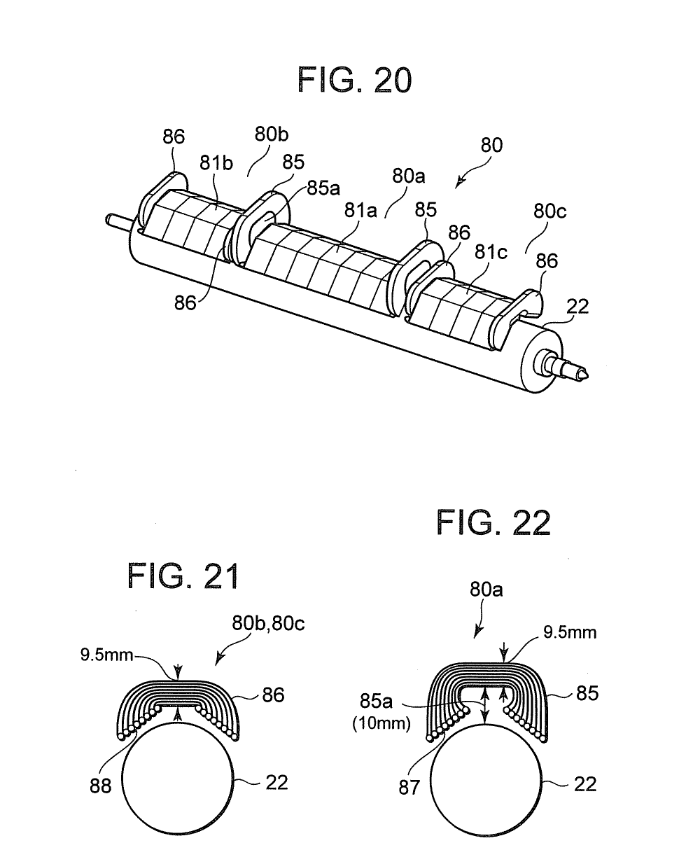

The third embodiment has, as shown in FIG. 18 to FIG. 22, an induction heating coil 80 that heats the heat roller 22. The induction heating coil 80 is divided into three coils, namely, a center coil 80a and first and second side coils 80b and 80c. The center coil 80a has a length of 200 mm. The full length 320 mm of the heat roller 22 is heated by the center coil 80a and the first and the second side coils 80b and 80c.

In the induction heating coil 80, the litz wire 60 same as that in the second embodiment is used as a conductor. The induction heating coil 80 is formed by winding the litz wire 60 around magnetic cores 81a, 81b, and 81c same as those in the second embodiment, for example, eight times. At ends of the magnetic cores 81a, 81b, and 81c, litz wires 60 are stacked in a direction apart from the heat roller 22 to form stacked coil sections 85 and 86. A shape of the stacked coil sections 85 on both sides of the center coil 80a is different from a shape of the stacked coil sections 86 on both sides of the first and the second side coils 80b and 80c.

The stacked coil sections 86 on both the sides of the first and the second side coils 80b and 80c have the same shape as the stacked coil sections 76 according to the second embodiment. In other words, the stacked coil sections 86 are formed in a range of height of 9.6 mm from inner peripheries of active coil sections 88. On the other hand, the stacked coil sections 85 on both the sides of the center coil 80a are formed in a range of height of 9.6 mm above spaces 85a having a height of 10 mm from an inner periphery of an active coil section 88. The stacked coil sections 85 and the stacked coil sections 86 are formed in this way to reduce opposed areas of the stacked coil sections 85 and the stacked coil sections 86.

In such an induction heating coil 80, as in the second embodiment, whereas the first coil width β of the active coil sections 87 and 88 is set to 20.8 mm, the second coil bending width γ of stacked coil sections 85 and 86 is formed at about 4.3 mm.

By stacking the litz wires 60 to form the stacked coil sections 85 and 86 in this way, it is possible to set the width of joint portions θ5 and θ6 of the center coil 80a and the first and the second side coils 80b and 80c to 8.6+1=9.6 mm. In other words, compared with a simply wound coil, it is possible to narrow the joint portions θ5 and θ6 with weak magnetic fields of the induction heating coil 80 and intensify the magnetic fields of the joint portions θ5 and θ6. A gap of about 1 mm is provided in the joint portions of the center coil 80a and the first and the second side coils 80b and 80c to prevent the adjacent coils from coming into contact with each other. An insulating material may be provided instead of the gap to prevent the contact of the adjacent coils.

It is also possible to reduce the width of both ends η5 and η6 of the first and the second side coils 80b and 80c and intensify magnetic fields of both the ends η5 and η6 of the first and the second side coils 80b and 80c. As a result, it is possible to further reduce a temperature fall of the metal conductive layer 22c in the joint portions θ5 and θ6 and at both the ends η5 and η6 of the induction heating coil 80 and reduce temperature unevenness of the heat roller 22.

It is also possible to increase a ratio of the load resistance R to the inductance L by compressing the litz wires 60 of the stacked coil sections 85 and 86 at the ends of the induction heating coil 80 to reduce areas of the stacked coil sections 85 and 86. In other words, a ratio of reactive currents in the induction heating coil 80 is reduced. Therefore, the magnetic combination of the induction heating coil 80 and the heat roller 22 is strong and, when the same heat generation amount is obtained, it is possible to reduce an electric current fed to the induction heating coil 80 and improve heating efficiency of the induction heating coil 80. When the electric current flowing to the induction heating coil 80 is small, even if a size of a litz wire is the same, it is possible to reduce a copper loss. As a result, it is possible to improve heating efficiency of the heat roller 22 and save energy consumption of the fixing device 11.

Moreover, a shape of the stacked coil sections 85 of the center coil 80a and a shape of the stacked coil sections 86 of the first and the second side coils 80b and 80c are different. A phase of the stacked coil sections 85 and a phase of the stacked coil sections 86 are shifted. In other words, compared with a coil in which all shapes of stacked coil sections are the same, opposed areas of the stacked coil sections 85 and the stacked coil sections 86 are reduced. Therefore, in the joint portions θ5 and θ6 of the induction heating coil 80, it is possible to reduce a mutual induction current generated between the center coil 80a and the first and the second side coils 80b and 80c. As a result, it is possible to reduce adverse influences of noise caused by the mutual induction current generated between the stacked coil sections 85 and the joint portions θ5 and θ6 of the stacked coil sections 86.

Moreover, since the litz wires 60 of the coil sections 85 and 86 are compressed to reduce opposed areas of the stacked coil sections 85 and the stacked coil sections 86, it is possible to reduce adverse influences of noise caused by the mutual induction current generated between the stacked coil sections 85 and the joint portions θ5 and θ6 of the stacked coil sections 86.

Furthermore, by compressing the litz wires 60 and reducing the height λ of the stacked coil sections 86, in the induction heating coil 80, it is possible to reduce the full length of the litz wire 60 while securing the active coil sections 87 and 88 of a necessary length. As a result, when an electric current is generated, it is possible to reduce useless Joule heat due to a copper loss of the litz wire 60 and improve heat generation efficiency of the metal conductive layer 22c.

According to this embodiment, in the induction heating coil 80, the stacked coil sections 85 and 86 are formed by stacking the litz wires 60 at the ends of the magnetic cores 81a, 81b, and 81c. Therefore, as in the second embodiment, it is possible to form the stacked coil sections 85 and 86 to be very small such that the second coil width γ thereof is reduced to be equal to or smaller than ¼ of the first coil width β of the active coil sections 87 and 88. Consequently, when the full length of the heat roller 22 is heated, it is possible to reduce a temperature fall of the metal conductive layer 22c caused by the width of the joint portions θ5 and θ6 and the width of both the ends η5 and η6 of the induction heating coil 80. A more uniform fixing temperature is obtained over the full length of the heat roller 22.

Moreover, in this embodiment, the litz wires 60 in the stacked coil sections 85 and 86 are compressed to reduce areas of the stacked coil sections 85 and 86. As a result, it is possible to reduce a ratio of reactive currents of portions of the induction heating coil 80 not contributing to heating of the heat roller 22 and energy consumption of the fixing device 11 is saved according to improvement of heating efficiency of the induction heating coil 80.

In this embodiment, the stacked coil sections 85 and the stacked coil sections 86 are formed in different shapes and a phase of the stacked coil sections 85 and a phase of the stacked coil sections 86 are shifted. In addition, the litz wires 60 of the stacked coil sections 85 and 86 are compressed to reduce areas of the stacked coil sections 85 and 86. Therefore, it is possible to further reduce areas of the joint portions θ5 and θ6 of the induction heating coil 80 opposed to the stacked coil sections 85 and 86 and reduce a mutual induction current between the center coil 80a and the first and the second side coils 80b and 80c adjacent to the center coil 80a. As a result, it is possible to prevent malfunction of the inverter circuit 50 due to noise caused by the mutual induction current and surely heat the heat roller 22 to a desired fixing temperature.

Furthermore, by compressing the litz wires 60 and reducing the height λ of the stacked coil sections 85 and 86, it is possible to reduce the full length of the litz wire 60 of the induction heating coil 80 while securing the active coil sections 87 and 88 at a necessary length. As a result, when an electric current is generated, it is possible to reduce useless Joule heat due to a copper loss of the litz wire 60 and further improve heat generation efficiency of the metal conductive layer 22c.

The invention is not limited to the embodiments described above. Various modifications of the embodiments are possible within the scope of the invention. For example, the endless heating target member may be a fixing belt and the number of times of winding of the induction heating coil is not limited either. The induction heating coil may be a single coil rather than being divided into plural coils. In such a single induction heating coil, it is possible to prevent a temperature fall at both ends of the induction heating coil.

What is claims is:

1. An induction heating device comprising:
an endless heating target member that has a metal conductive layer; and
an induction heating coil that is arranged on an outer periphery of the heating target member and formed by winding a conductor plural times and generates an induction current in the metal conductive layer, wherein
a first coil width in a direction parallel to a rotation axis of the heating target member and a second coil width in a direction parallel to a rotating direction of the heating target member of the induction heating coil are different.

2. An induction heating device according to claim 1, wherein the (first coil width)>(second coil width).

3. An induction heating device according to claim 1, wherein the conductor is a litz wire.

4. An induction heating device according to claim 1, wherein a compression ratio of the conductor in the direction parallel to the rotation axis of the heating target member and a compression ratio of the conductor in the direction parallel to the rotating direction of the heating target member of the induction heating coil are different.

5. An induction heating device according to claim 1, wherein a winding angle of the conductor on an inner periphery of the induction heating coil from the direction parallel to the rotation axis to the direction parallel to the rotating direction is a substantially right angle.

6. An induction heating device according to claim 1, wherein
the heating target member is a heat roller, and
in a direction parallel to a rotation axis of the heat roller, the conductor is wound in a curved surface shape along an outer peripheral surface of the heat roller and a section of the conductor is an arcuate shape parallel to a surface of the heat roller.

7. An induction heating device according to claim 1, wherein, in the direction parallel to the rotation axis of the heating target member, the conductor is wound in a plane shape and an internal angle of a section of the conductor is fixed over a full length in a direction of the rotation axis of the heating target member.

8. An induction heating device comprising:
an endless heating target member that has a metal conductive layer; and
an induction heating coil that is arranged on an outer periphery of the heating target member and formed by winding a conductor plural times and generates an induction current in the metal conductive layer, wherein
a first coil width in a direction parallel to a rotation axis of the heating target member and a second coil width in a direction parallel to a rotating direction of the heating target member of the induction heating coil are different and the conductor in the direction parallel to the rotating direction is stacked in a direction apart from a surface of the heating target member.

9. An induction heating device according to claim 8, wherein the (first coil width)>(second coil width).

10. An induction heating device according to claim 8, wherein the conductor is a litz wire.

11. An induction heating device according to claim 8, wherein
the conductor is capable of changing a compression ratio of the conductor, and
a compression ratio of the conductor in the direction parallel to the rotation axis of the heating target member and a compression ratio of the conductor in the direction parallel to the rotating direction of the heating target member of the induction heating coil are different.

12. An induction heating device according to claim 8, wherein a winding angle of the conductor on an inner periphery of the induction heating coil from the direction parallel to the rotation axis to the direction parallel to the rotating direction is a substantially right angle.

13. An induction heating device according to claim 8, wherein
the heating target member is a heat roller, and
in a direction parallel to a rotation axis of the heat roller, the conductor is wound in a curved surface shape along an outer peripheral surface of the heat roller and a section of the conductor is an arcuate shape parallel to a surface of the heat roller.

14. An induction heating device according to claim 8, wherein, in the direction parallel to the rotation axis of the heating target member, the conductor is wound in a plane shape and an internal angle of a section of the conductor is fixed over a full length in a direction of the rotation axis of the heating target member.

15. An induction heating device according to claim 8, wherein the conductor stacked in the direction apart from the surface of the heating target member is formed in substantially linearly.

16. An induction heating device according to claim 8, wherein the conductor stacked in the direction apart from the surface of the heating target member is stacked in a direction perpendicular to the surface of the heating target member.

17. An induction heating device according to claim 8, wherein a plurality of the induction heating coils are arranged in a direction of the rotation axis of the heating target member.

18. An induction heating device according to claim 17, wherein shapes of the induction heating coils in portions where the plural induction heating coils are adjacent to and opposed to one another are different from one another.

19. An induction heating fixing device comprising:
an endless heating target member that has a metal conductive layer;
an induction heating coil that is arranged on an outer periphery of the heating target member and formed by winding a conductor plural times and generates an induction current in the metal conductive layer; and
a pressing member that comes into press-contact with the heating target member and nips and carries a fixing target medium in a predetermined direction together with the heating target member, wherein
a first coil width in a direction parallel to a rotation axis of the heating target member and a second coil width in a direction parallel to a rotating direction of the heating target member of the induction heating coil are different.

20. An induction heating fixing device according to claim 19, wherein the (first coil width)>(second coil width).

21. An induction heating fixing device according to claim 19, wherein a compression ratio of the conductor in the direction parallel to the rotation axis of the heating target member and a compression ratio of the conductor in the direction parallel to the rotating direction of the heating target member of the induction heating coil are different.

22. An induction heating fixing device according to claim 19, wherein a winding angle of the conductor on an inner periphery of the induction heating coil from the direction parallel to the rotation axis to the direction parallel to the rotating direction is a substantially right angle.

23. An induction heating fixing device comprising:
an endless heating target member that has a metal conductive layer;
an induction heating coil that is arranged on an outer periphery of the heating target member and formed by winding a conductor plural times and generates an induction current in the metal conductive layer; and
a pressing member that comes into press-contact with the heating target member and nips and carries a fixing target medium in a predetermined direction together with the heating target member, wherein
a first coil width in a direction parallel to a rotation axis of the heating target member and a second coil width in a direction parallel to a rotating direction of the heating target member of the induction heating coil are different and the conductor in the direction parallel to the rotating direction is stacked in a direction apart from a surface of the heating target member.

24. An induction heating fixing device according to claim 23, wherein the (first coil width)>(second coil width).

25. An induction heating fixing device according to claim 23, wherein a compression ratio of the conductor in the direction parallel to the rotation axis of the heating target member and a compression ratio of the conductor in the direction parallel to the rotating direction of the heating target member of the induction heating coil are different.

26. An induction heating fixing device according to claim 23, wherein a winding angle of the conductor on an inner periphery of the induction heating coil from the direction parallel to the rotation axis to the direction parallel to the rotating direction is a substantially right angle.

27. An induction heating fixing device according to claim 23, wherein the conductor stacked in the direction apart from the surface of the heating target member is stacked in a direction perpendicular to the surface of the heating target member.

28. An induction heating fixing device according to claim 25, wherein a plurality of the induction heating coils are arranged in a direction of the rotation axis of the heating target member and shapes of the induction heating coils in portions where the plural induction heating coils are adjacent to and opposed to one another are different from one another.
